(19) United States
(12) Patent Application Publication
(10) Pub. No.: US 2025/0037182 A1
(43) Pub. Date: Jan. 30, 2025

(54) Progressively Trained Machine Learning for Recommendations

(71) Applicant: Capital One Services, LLC, McLean, VA (US)

(72) Inventors: Alexander Gurfinkel, West Hollywood, CA (US); Srikanth Bongu, Plano, TX (US); Nicholas Nitta, Frisco, TX (US); Robert Byron, Plano, TX (US)

(21) Appl. No.: 18/225,437

(22) Filed: Jul. 24, 2023

(51) Int. Cl. G06Q 30/0601; G06Q 30/0201

(52) U.S. Cl. CPC G06Q 30/0631; G06Q 30/0206

(57) ABSTRACT

Methods, systems, and apparatuses are described herein for progressively training an auto recommendation machine learning model based on differences between customer automobile searching preferences and actual automobile purchasing behavior. Search data indicating a history of auto shopping searches by one or more users may be received. Training data may be generated based on the search data and historical vehicle financing data and used to train a machine learning model. Auto shopping preference information may be received and provided as input to the trained machine learning model, which may output one or more recommended automobiles. After display of those one or more recommended automobiles, the system may receive an indication of an automobile purchased by a user and determine a difference between the automobile purchased by the user and the automobile shopping preference information. Based on that difference, the trained machine learning model may be further trained.

### FIELD OF USE

Aspects of the disclosure relate generally to machine learning. More specifically, aspects of the disclosure may provide for improvements to machine learning by analyzing differences in expressed user preferences and actual user behavior and using those differences to progressively train a machine learning model trained to output recommendations.

### BACKGROUND

Machine learning models can be trained to perform a variety of tasks. For example, a machine learning model can be trained, using training data comprising a plurality of images of dogs and corresponding labels of where the dogs are (and/or are not) located, to identify dogs in images. In turn, machine learning techniques have become a promising way to analyze data and, based on that data, output recommendations and analysis. For example, cybersecurity professionals might use machine learning to analyze voluminous log data to identify the possibility of an attack, and sales professionals might use machine learning to analyze various market data to identify sales opportunities.

Machine learning models are trained based on training data, and the accuracy of those machine learning models often depends on the comprehensiveness and accuracy of the training data used. Returning to the dog image analysis above, if one or more images in the training data are incorrectly labeled or otherwise feature errors, this can cause a machine learning model trained using that training data to feature errors. This can have significant unintended consequences: after all, users of a machine learning model rarely have the time or ability to fully analyze the training data used to train that machine learning model.

Aspects described herein may address these and other problems, and generally improve the process of machine learning training by detecting circumstances where actual user behavior differs from expressed user preferences used to train a machine learning model and using those differences to further train the machine learning model.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to progressively training an auto recommendation machine learning model based on differences between customer automobile searching preferences and actual automobile purchasing behavior. A machine learning model may be trained based on a web browsing history of users. This information might be collected digitally, such as through analysis of searches and/or links clicked by users when accessing car sales websites. Such training data might train a machine learning model to recommend vehicles for purchase. The machine learning model may then be provided input data associated with shopping preferences of a particular user. For example, if a user searches auto shopping sites for minivans, then that information may be provided as input to the trained machine learning model, which may in turn provide output comprising automobile recommendations for the user (e.g., output recommended minivans). That said, the actual vehicles purchased by a user might differ from what they shopped/browsed for. For example, despite shopping for a minivan, a user might buy a sports car. In such a circumstance, the machine learning model may be further trained based on a difference between the automobile actually purchased by the user and the automobile shopping preferences expressed by the user (e.g., through their web browsing and/or search engine activity). In this way, the actual shopping behavior of the user (in contradiction to their web browsing activity) might be used to correct such inaccuracies and help the machine learning model be significantly more accurate.

More particularly, a computing device may receive, from one or more search engines, search data indicating a history of auto shopping searches by one or more users. The computing device may generate training data comprising the search data and historical vehicle financing data. The computing device may generate a trained machine learning model by modifying, based on the training data, one or more weights of one or more nodes of an artificial neural network. The computing device may receive, from a user, automobile shopping preference information and then provide, as input to the trained machine learning model, the automobile shopping preference information. The computing device may receive, as output from the trained machine learning model, one or more recommended automobiles and then cause display, in a user interface, of the one or more recommended automobiles. The computing device may then receive, after the display of the one or more recommended automobiles, an indication of an automobile purchased by the user. The computing device may determine a difference between the automobile purchased by the user and the automobile shopping preference information and further train the trained machine learning model by modifying, based on the difference between the automobile purchased by the user and the automobile shopping preference information, the one or more weights of the one or more nodes of the artificial neural network.

The training data used to train the machine learning model might be based on a variety of different data points, including searches made online by various users, auto loans initiated by various users, automobiles purchased by the various users, one or more vehicles already owned by the various users, and the like. In this manner, other users' shopping activity might be associated with cars that they own and/or owned. Along those lines, generating the training data may comprise determining a user associated with both a first search indicated by the history of auto shopping searches and a first auto loan indicated by the historical vehicle financing data and then adding, to the training data, an association between the fist search and the first auto loan.

The automobile shopping preference information may be captured and/or represented in a variety of ways. For example, the computing device may cause, based on the output from the trained machine learning model and in the user interface, output of a QR code that represents a Uniform Resource Locator (URL). That QR code might be usable to allow auto dealers to scan the URL and determine the user's automobile shopping preference information. In turn, the computing device may provide, at a web page at the URL, the automobile shopping preference information.

Determining the difference between the automobile purchased by the user and the automobile shopping preference information may be performed in a variety of ways. For example, the computing device may determine that a feature indicated in the automobile shopping preference information is not available in the automobile purchased by the user. For example, the sports car may have heated seats, whereas the minivans shopped for by a user might not. As another example, the computing device may determine that a price associated with the automobile purchased by the user is different from a range of prices indicated by the automobile shopping preference information. For example, the consumer might have shopped for frugal minivans online, but might have paid a significantly greater sum for a sports car after such searches.

Output from the trained machine learning model may be represented in a variety of ways. For example, the computing device may, as part of causing display of the one or more recommended automobiles, cause display of dealer information corresponding to each of the one or more recommended automobiles and then transmit, to each dealer associated with the one or more recommended automobiles, an indication of the user.

The computing device may determine a vehicle actually purchased by a user in a variety of ways. For example, the computing device may access an e-mail account associated with the user, process one or more e-mails of the e-mail account to identify an e-mail associated with an automobile purchase, and determine, based on the e-mail associated with an automobile purchase, the indication of the automobile purchased by the user. As another example, the computing device may receive, via the user interface, user input comprising the indication of the automobile purchased by the user.

Corresponding method, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a system comprising servers (including machine learning servers, search engine servers, website servers, and e-mail servers) and user devices.

FIG. 4A depicts the training of a machine learning model to generate a trained machine learning model.

FIG. 4B depicts how input, to a trained machine learning model, of collected automobile shopping preference information may cause output of recommended automobiles.

FIG. 5 depicts a flow chart comprising steps which may be performed for progressively training an auto recommendation machine learning model based on differences between customer automobile searching preferences and actual automobile purchasing behavior.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, a user might indicate their automobile shopping preferences online through the searches they conduct for vehicles to buy. For instance, a user searching for used minivans under ten thousand dollars indicates, in a broad sense, a desire for a lower-priced, used vehicle with a large number of seats, and likely suggests a desire for a relatively comfortable vehicle. These searches-and the activity of a user (e.g., which listings they click on or do not click on)-can be used as input to a machine learning model that is trained to output vehicle recommendations. For instance, that trained machine learning model (e.g., a machine learning model trained based on a history of searches and automobile purchases made by other users) might output recommendations for reasonably-priced used vehicles with a large number of seats, but might not recommend an expensive new sports car or a two-seater truck. That said, the searches of a user (and/or other ways they evince automobile shopping preferences) might contradict their actual purchasing activity. For instance, once the same user goes to a dealer, they might end up shopping for two-seater sports cars and buying one for a variety of reasons. As will be detailed herein, the difference between the user's actual purchasing activity and the user's preferences might be used to further train the trained machine learning model. In this manner, the trained machine learning model might be able to provide more accurate recommendations: for instance, it might still recommend reasonably-priced used vehicles with a large number of seats, but might also occasionally include a two-seater sports car as an alternative option for the user.

As an example of how the present disclosure may operate, a machine learning model might be trained using a history of automobile shopping activities of other users and corresponding automobiles that those users own, such that the machine learning model is trained to recommend vehicles to users. A user might be in the market for a new sedan, and might conduct a variety of online searches for new and used sedans in their town. That search information (and/or any other ways the user indicates what vehicles they are looking for) may be provided as input to the trained machine learning model, which may in turn recommend one or more automobiles (e.g., new/used sedans) for the user to consider. That said, it may turn out that the same user might end up purchasing a truck outside of their area for a variety of reasons: the truck might have been unexpectedly cheap outside of town and thus more attractive to the user, the user might have secretly wanted a truck but might have been unwilling to admit it, or the like. The difference between the user's previous automobile shopping preferences (e.g., the desire for local sedans) and the user's actual shopping activity (e.g., the purchase of a truck outside of town) might be used to further train the trained machine learning model. In this way, the trained machine learning model might become more accurate by learning, over time, the various factors and circumstances that might cause a user to purchase one vehicle over another. In other words, the trained machine learning model might learn actual consumer preferences, rather than their expressed consumer preferences.

Aspects described herein improve the functioning of computers by improving the process of machine learning. Conventional machine learning models learn via training data, and the fidelity and accuracy of that training data has significant effects on the accuracy and usefulness of a trained machine learning model. There are practical limitations on the improvement of such training data: after all, it might come from the innocent and intentional shopping searches of users, but those searches might not in fact reflect their actual shopping desires. The process described herein remedies the issue of the reliability of this training data by effectuating a feedback loop whereby, in circumstances where training data conflicts with actual user behavior, a machine learning model is further trained based on such conflict. In this manner, the computer-implemented machine learning model is faster, more accurate, and more useful overall.

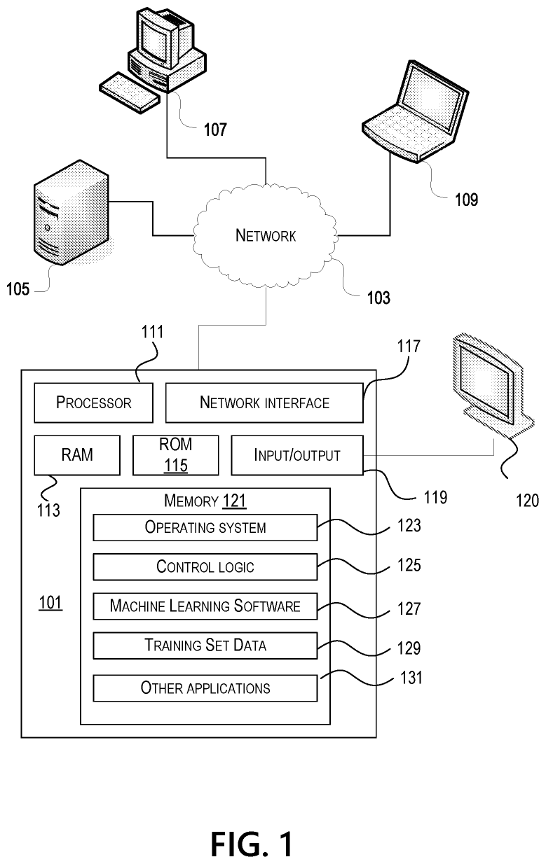

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

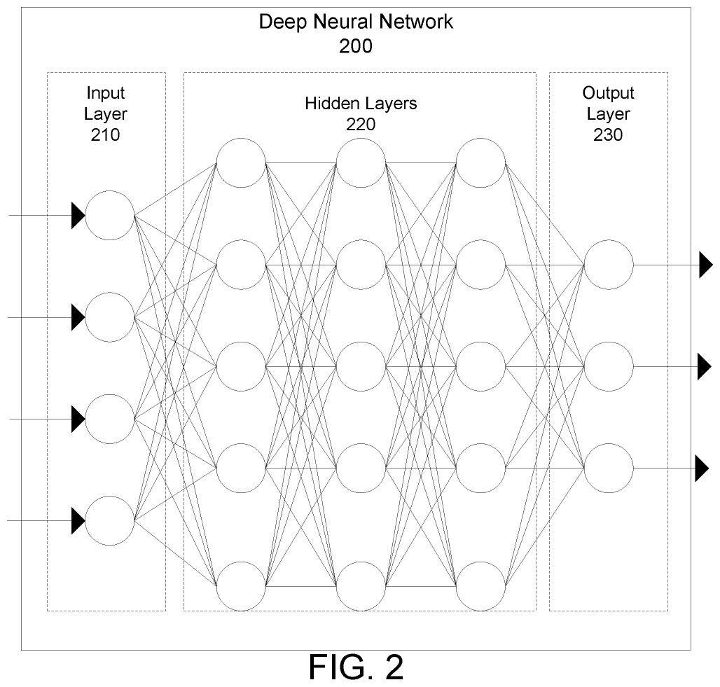

FIG. 2 illustrates an example deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

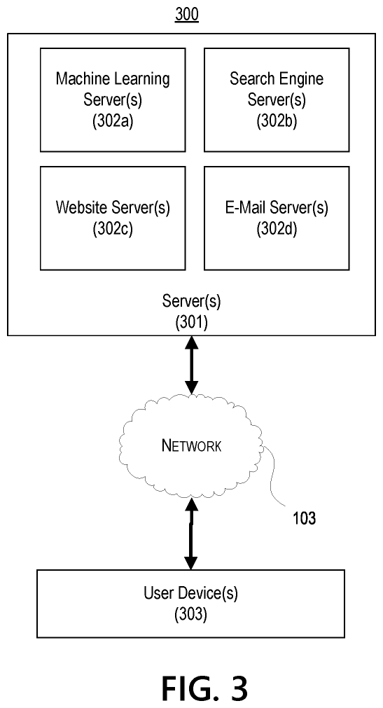

FIG. 3 depicts a system 300 comprising one or more servers 301 (that include one or more machine learning servers 302a, one or more search engine servers 302b, one or more website servers 302c, and/or one or more e-mail servers 302d) communicatively coupled, via the network 103, to one or more user devices 303. The one or more servers 301 and/or the one or more user devices 303 may comprise computing devices, such as computing devices that comprise one or more processors and memory storing instructions that, when executed on the one or more processors, cause the performance of one or more steps. The one or more servers 301 and/or the one or more user devices 303 may comprise any of the devices depicted with respect to FIG. 1, such as one or more of the computing devices 101, 105, 107, and/or 109.

The servers 301 may comprise one or more computing devices configured to, for example, train and/or execute machine learning models, receive and transmit data, and the like. For example, at least one of the one or more servers 301 may be configured to collect information about user searches for automobiles, use that information to train a machine learning model, use the machine learning model to output automobile recommendations, and then re-train the machine learning model based on whether the actual purchases made by a user conflict with their searches.

The one or more machine learning servers 302a may be configured to manage machine learning. For instance, the one or more machine learning servers 302a may be configured to train machine learning models, provide input to those trained machine learning models, and/or receive output from those trained machine learning models. This may involve storing data and/or managing (e.g., executing) applications associated with the deep neural network architecture 200. The one or more machine learning servers 302a may be configured to train a machine learning model by causing one or more nodes of an artificial neural network to be weighted based on training data. The one or more machine learning servers 302a may be configured to provide input to that trained machine learning model by, for example, providing input to an input node of the artificial neural network. The one or more machine learning servers 302a may be configured to receive output from that trained machine learning model by, for example, receiving data from an output node of the artificial neural network.

The one or more search engine servers 302b may provide services that enable users to conduct searches. For example, the one or more search engine servers 302b may be configured to provide users the ability to search for automobiles using a search query (e.g., “cheap cars”), one or more criteria (e.g., under ten thousand dollars, automatic transmission), or the like. The one or more search engine servers 302b may be configured to provide results based on the searches. For example, the one or more search engine servers 302b may communicate with one or more databases to determine, based on search queries provided by users, one or more results to the search queries. Though referred to as one or more search engine servers 302b, the one or more search engine servers 302b might be part of a larger website, such as a car shopping website. As will be described in further detail below, a user's activity associated with such searches might be collected and used to determine one or more users' automobile shopping preferences, which might be used to train a machine learning model.

The one or more website servers 302c may provide one or more webpages to one or more users over, for example, the Internet. For instance, the one or more website servers 302c may work in conjunction with the one or more search engine servers 302b to provide a car shopping search website. As another example, the one or more website servers 302c may be configured to provide user auto shopping preferences by, for instance, providing users' auto shopping preferences for a particular user at a URL uniquely associated with that user. The one or more website servers 302c might be part of an automobile search system, and/or might be usable to allow users to provide a barcode (e.g., a QR code) associated with a URL that allows those scanning the barcode (e.g., dealers) to retrieve the user's automobile shopping preferences.

The one or more e-mail servers 302d may provide e-mail services to one or more users. For example, the one or more e-mail servers 302d may store e-mails associated with a particular user, allow that user to send e-mails, and the like. As will be further detailed below, such e-mails may be used in certain circumstances to identify when a user has purchased an automobile through, e.g., natural language processing of e-mails of the user.

Though the one or more machine learning servers 302a, the one or more search engine servers 302b, the one or more website servers 302c, and the one or more e-mail servers 302d are shown as separate, these servers may execute on one or more of the same servers of the one or more servers 301. For example, the same server that trains a machine learning model may additionally provide an automobile search engine. In this manner, the one or more servers 301 may be configured in a wide variety of ways to suit the needs of different organizations and/or users.

The one or more user devices 303 may comprise laptops, desktops, smartphones, or similar computing devices. The one or more user devices 303 may be configured to display user interfaces and receive user input via those user interfaces. For example, the one or more user devices 303 may be configured to allow a user to provide, via a user interface, indication of whether output from one or more machine learning models is correct or incorrect. As another example, the one or more user devices 303 may be configured to access websites provided by the one or more website servers 302c and/or search via the one or more search engine servers 302b.

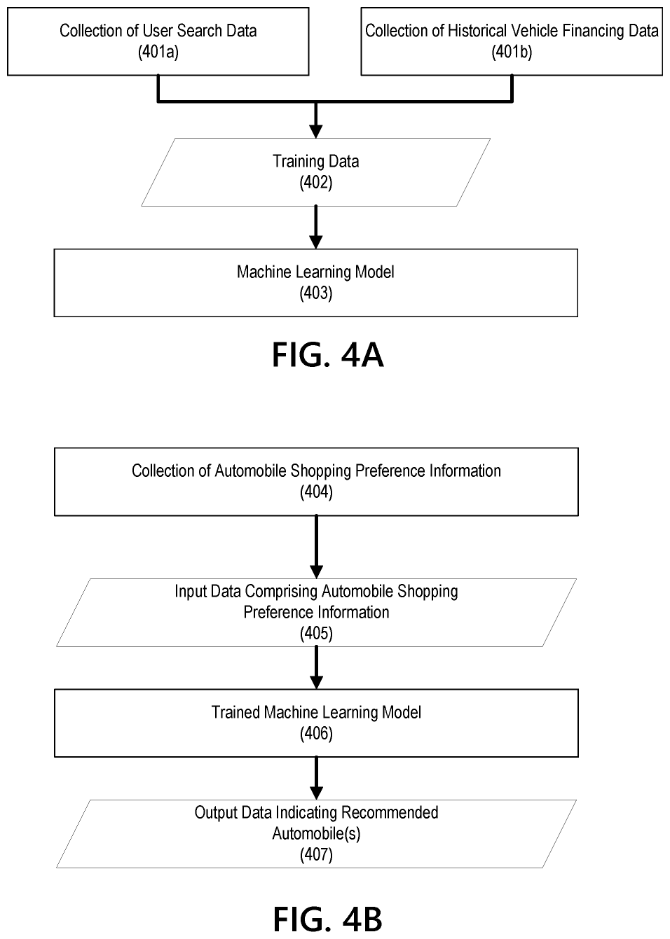

FIG. 4A depicts how a machine learning model represented by element 403, such as one that might be implemented via the one or more machine learning servers 302a, might be trained. Specifically, FIG. 4A depicts how search data (e.g., reflected based on searches conducted via the one or more search engine servers 302b) and historical vehicle financing data might collected into training data, which might be used to train a machine learning model to provide automobile recommendations.

Element 401a reflects the collection of user search data. User search data may comprise any activity conducted by one or more users when shopping for automobiles, and might include search queries (e.g., “fast American sports car”), web pages browsed by a user (e.g., a page listing vintage Japanese automobiles), filter options selected by a user (e.g., automatic transmission vehicles), specific automobiles evaluated by the user (e.g., the fact that a user clicked a link for a particular vehicle), and the like. Such activity may be monitored and collected in a variety of ways. For example, the activity may be monitored using a JavaScript script integrated into a web page, using a browser plug-in, by monitoring packet transmissions between one or more of the user devices 303 and any one of the servers 301, or the like.

Element 401b reflects the collection of historical vehicle financing data. Historical vehicle financing data may reflect purchases, by one or more users, of vehicles, loans associated with vehicles, payments for insurance for vehicles, and the like. Such information is useful in that it reflects ownership of vehicles, which might in turn indicate vehicles purchased by users. In conjunction with the user search data, and as correlated by user, this data might thereby indicate what users search for before they buy particular vehicles, as well as what sort of vehicles users search and potentially buy for when they already own a particular vehicle. The historical vehicle financing data may be retrieved from one or more databases, such as a bank database storing financial information for a user.

As the user search data and the historical vehicle financing data relate to particularly personal information of one or more users, the scope and access to such information may be limited based on user input. For example, a user may specify whether they wish to share search data and/or their vehicle financing data, and the information collected as reflected in element 401a and 401b may be accordingly limited. This is another reason why the trained machine learning model might, without the benefit of the further training described herein, be inaccurate and/or limited.

Element 402 reflects the training data, which may be a combination of the user search data of element 401a, the historical vehicle financing data of element 401b, and other data. In this manner, the training data may reflect both how one or more users browse and/or search for automobiles as well as which vehicle(s) those user(s) own and/or purchase. Additional data that might be useful in evaluating those purchasing habits, such as the size of the user(s) family, their income level, and their history of driving infractions, might be also added to the training data as available. Such information might be retrieved from the same or similar databases as the historical vehicle financing data.

Element 403 reflects a machine learning model, which might be trained based on the training data represented by element 402. In this manner, a trained machine learning model might be generated by training, using the training data represented by element 402, the trained machine learning model. Such training may comprise modifying the weights of one or more nodes of an artificial neural network based on the training data.

FIG. 4B reflects how the trained machine learning model generated in FIG. 4A might be used to output recommended automobiles. In short, FIG. 4B shows how automobile shopping preference information (e.g., searches by a particular user, a user's indication of what they want in a vehicle via a form, or the like) might be provided as input to a trained machine learning model, which might in turn provide output indicating one or more recommended automobiles.

Element 404 reflects the collection of automobile shopping preference information. The automobile shopping preference information may reflect any information that indicates preferences of a user pertaining to automobiles. This information might be, but need not, be the same or similar as the user search data discussed in element 401a of FIG. 4A. For example, the automobile shopping preference information might indicate color preferences, size preferences, transmission preferences, price preferences, location preferences, brand preferences, towing capacity measurements, or the like. The automobile shopping preference information might be provided via a form, such as an electronic form filled out by a user. The automobile shopping preference information might additionally and/or alternatively be provided via a search history of a user, such as a search query provided by the user, one or more web pages browsed by the user, and/or one or more categories selected by the user.

Element 405 reflects input data to be provided to the trained machine learning model. The input data may comprise the automobile shopping preference information collected as part of element 404. The input data may be pre-processed in a variety of ways: for example, incomplete data entries might be removed and/or unnecessary portions of data might be removed.

Element 406 reflects the trained machine learning model, which might be the product of the flow chart depicted in FIG. 4A. In other words, the trained machine learning model reflected by element 406 may be the machine learning model reflected in element 403 once trained using the training data reflected by element 402.

Element 407 reflects output data that might be provided by the trained machine learning model in response to the input data reflected by element 405. The output data may be formatted in a variety of ways. For example, the output data may comprise a list of automobiles makes, models, and years. As another example, the output data may comprise unique identifications of new and/or used automobiles for sale. The output data may comprise links to web pages, such as listings for new and/or used vehicles. Such links might be tracked such that user access to those web pages is logged and used to further train the machine learning model.

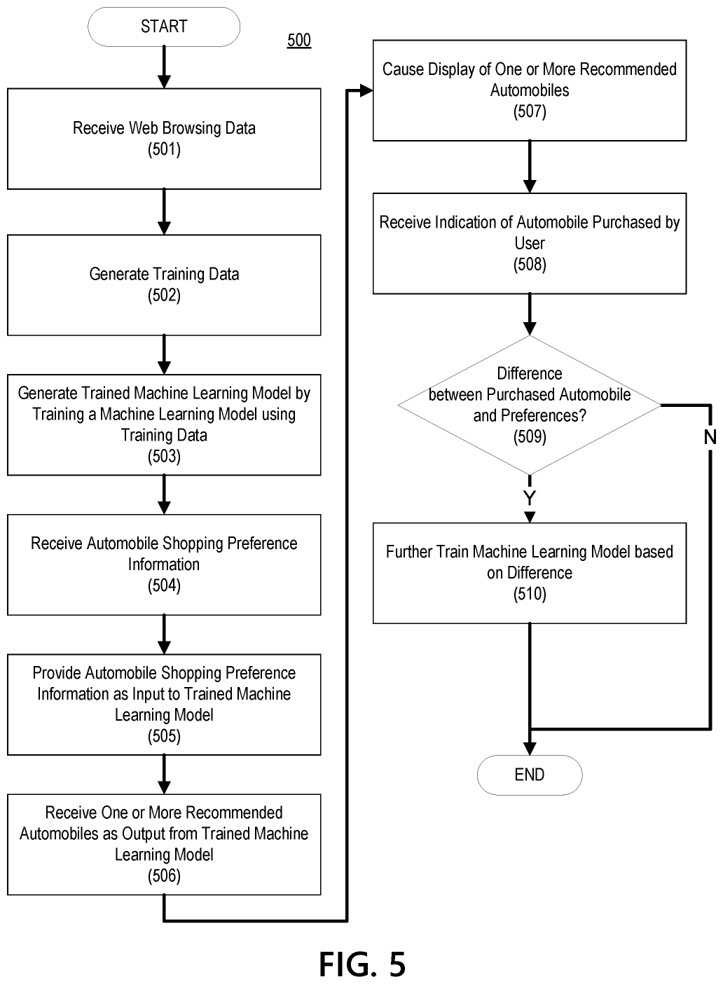

FIG. 5 depicts a flow chart depicting a method 500 comprising steps which may be performed for progressively training an auto recommendation machine learning model based on differences between customer automobile searching preferences and actual automobile purchasing behavior. A computing device may comprise one or more processors and memory storing instructions that, when executed by the one or more processors, cause performance of one or more of the steps of FIG. 5. One or more non-transitory computer-readable media may store instructions that, when executed by one or more processors of a computing device, cause the computing device to perform one or more of the steps of FIG. 5. Additionally and/or alternatively, one or more of the devices depicted in FIG. 3, such as the one or more servers 301 and/or the one or more user devices 303, may be configured to perform one or more of the steps of FIG. 5. Moreover, all or portions of the steps of FIG. 5 may be the same or similar as the elements and concepts depicted with respect to FIG. 4A and/or FIG. 4B. For simplicity, the steps below will be described as being performed by a single computing device: however, this is merely for simplicity, and any of the below-referenced steps may be performed by a wide variety of computing devices, including multiple computing devices.

In step 501, the computing device may receive web browsing data. For example, the computing device may receive, from one or more search engines, search data indicating a history of auto shopping searches by one or more users. The web browsing data may relate to a variety of searches (e.g., queries provided to search engines) performed by users with respect to automobiles. The web browsing data need not be relegated exclusively to searches. For example, the web browsing data may comprise links clicked by a user (e.g., search results accessed by the user, web pages accessed by the user), categories of a website browsed by a user (e.g., that the user selected a “minivans” page on a used car website), and the like.

In addition to step 501, the computing device may collect additional information relating to ownership, by one or more users, of one or more vehicles. For example, the computing device may collect, from one or more databases, information about financial transactions conducted by one or more users, then filter that information to identify transactions associated with automobiles. As another example, the computing device may retrieve, from a database, automobile loan documents, then process those documents using a natural language processing algorithm to identify one or more users associated with the documents. Through those and similar processes, the computing device may identify one or more automobiles owned (and/or previously owned) by users. In turn, such automobiles can be correlated with the web browsing data determined in step 501. This can be useful in at least two ways: it can indicate what sort of automobiles that users search for based on what automobiles they already own (or owned), and it can indicate what automobiles that users ultimately purchased based on their past searches.

In step 502, the computing device may generate training data. For example, the computing device may generate training data comprising the web browsing data (e.g., the search data), historical vehicle financing data, and/or any other information that relates to user automobile shopping activity and/or user automobile acquisition. For example, if available, information about user visits to auto dealers may be added to the training data. Such information may be determined via the e-mail servers 302d (e.g., by processing e-mails associated with a user to identify e-mails indicating that a user visited or planned to visit a particular dealer) and/or via geographic data (e.g., by detecting, using a GPS device of one or more of the user devices 303, that a user was close to the location of an auto dealer.

The training data may associate various data elements. Along those lines, generating the training data may comprise determining associations between users' searches and their automobile financing information. For example, the computing device may determine a user associated with both a first search indicated by the history of auto shopping searches and a first auto loan indicated by the historical vehicle financing data. In this way, the computing device may determine that a user with a particular shopping search history ultimately purchased (or already owned) a particular vehicle. The computing device may then, in such a circumstance, add, to the training data, an association between the first search and the first auto loan. As suggested above, this can thereby teach the machine learning model what sort of automobiles that users search for based on what automobiles they already own (or owned), and/or it can indicate what automobiles that users ultimately purchased based on their past searches.

In step 503, the computing device may generate a trained machine learning model by training a machine learning model using training data. For example, the computing device may generate a trained machine learning model by modifying, based on the training data, one or more weights of one or more nodes of an artificial neural network. The process of training may be the same or similar as described with respect to FIG. 4A.

In step 504, the computing device may receive automobile shopping preference information. The automobile shopping preference information, as discussed with respect to element 404 of FIG. 4B, may relate to any information that indicates preferences of a user pertaining to automobiles. For example, the automobile shopping preference information might indicate automobile color preferences, automobile size preferences, automobile seat preferences, automobile safety feature preferences, automobile transmission preferences, automobile price preferences, automobile location preferences, automobile brand preferences, automobile towing capacity measurements, or the like. For example, the computing device may receive, from a user, automobile shopping preference information via a user interface, such as a website, a mobile app, or the like.

The automobile shopping preference information may be usable by a user to easily provide details about their shopping preferences to others. This provides incentive for a user to provide the automobile shopping preference information in the first place: it allows them to more easily shop for vehicles of their preference. For example, the computing device may cause, based on the output from the trained machine learning model and in the user interface, output of a QR code that represents a Uniform Resource Locator (URL), and then provide, at a web page at the URL, the automobile shopping preference information. In this way, a user might be able to use the QR code to quickly and easily provide dealers a scannable code that allows the dealer to quickly identify vehicles of interest to the user. Moreover, access to the URL associated with the QR code might be usable to identify when a user visits a particular dealer. For example, if a particular Internet Protocol (IP) address associated with a dealer accesses the URL, that might be used to infer that a user associated with the URL went to the dealer. In turn, the fact that the user went to the dealer might be later included as part of the training data of step 502 (and/or the further training of step 510) to further provide information about the shopping preferences of the user.

In step 505, the computing device may provide the automobile shopping preference information as input to the trained machine learning model. For example, the computing device may provide, as input to the trained machine learning model, the automobile shopping preference information. As a particular example, the automobile shopping preference information may be provided via one or more input nodes of an artificial neural network. If necessary, the automobile shopping preference information may be pre-processed to, for example, remove errors, improve consistency, and the like. As a simple example, vehicle names may be made consistent: for example, two entries (e.g., “GMC Denali” and “General Motors Corporation Yukon Denali”) might be edited to be consistent (e.g., so that both are “GMC Yukon Denali”).

In step 506, the computing device may receive one or more recommended automobiles as output from the trained machine learning model. For example, the computing device may receive, as output from the trained machine learning model, one or more recommended automobiles. The one or more recommended automobiles may comprise recommendations of automobiles that the user might be interested in considering for purchase. As a simple example, if the automobile shopping preference information indicates that a user wants a light-weight but reasonably easy-to-maintain used sports car, the one or more recommended automobiles may comprise a used Lotus and a new Toyota 86. That said, the recommendations need not be bound to the preferences of the user. For example, if a user indicates that they are interested in a sedan, various crossovers and vans might be recommended based on past indications that users shopping for sedans also cross-shopped for crossovers and vans. Indeed, one advantage of the training (and further training) processes described herein is that the machine learning model may make recommendations that are not bound to the explicit desires of the user, but instead infer what the user might be interested in based on past shopping activity of other users and use that to provide more useful and thought-provoking recommendations.

In step 507, the computing device may cause display of the one or more recommended automobiles. The one or more recommended automobiles may be output via a user interface, such as via a display of one or more of the user devices 303. For example, the computing device may cause display, in a user interface, of the one or more recommended automobiles.

Causing display of the one or more recommended automobiles may comprise displaying detail about purchase opportunities for the one or more recommended automobiles, such as the location of the automobiles, the price of the automobiles, the features of the automobiles, and the like. For example, the computing device may cause display of dealer information corresponding to each of the one or more recommended automobiles and transmit, to each dealer associated with the one or more recommended automobiles, an indication of the user. The manner in which that information is displayed may be usable, by the user, to continue their shopping. For example, links to dealer websites and/or automobile listings may be provided as part of display of the one or more recommended automobiles. Such links may be implemented using tracking links, such that further user activity (e.g., the clicking of the links) may be monitored and used to further train the trained machine learning model.

In step 508, the computing device may receive an indication of an automobile purchased by a user. The indication may be any sign that a user purchased an automobile, including an explicit indication of the automobile purchased, the location (e.g., the dealer) where the automobile was purchased, and the like. For example, the computing device may receive, after the display of the one or more recommended automobiles, an indication of an automobile purchased by the user.

The indication of the automobile purchased by the user may be received in a variety of ways that directly or indirectly evince the acquisition of an automobile by a user. This process may be effectuated via e-mail. For example, the computing device may access an e-mail account associated with the user, process one or more e-mails of the e-mail account to identify an e-mail associated with an automobile purchase, and determine, based on the e-mail associated with an automobile purchase, the indication of the automobile purchased by the user. This e-mail scanning process may advantageously allow the computing device to identify that a user has purchased a vehicle without requiring the user to explicitly detail such a purchase. With that said, such e-mail scanning might be conditioned on the appropriate permissions provided by the user, given the privacy of e-mail communications.

Additionally and/or alternatively, a user might themselves provide information about their acquisition of an automobile. Stated differently, the user themselves might inform the computing device that they purchased an automobile. For example, the computing device may receive, via the user interface, user input comprising the indication of the automobile purchased by the user. The indication might comprise, for example, a user selection of a make, model, location, model year, and the like.

In step 509, the computing device may determine whether there are any differences between the purchased automobile indicated in step 508 and the automobile shopping preference information from step 504. For example, the computing device may determine a difference between the automobile purchased by the user and the automobile shopping preference information. If so, the method 500 proceeds to step 510. Otherwise, the method 500 ends.

The difference(s) between the purchased automobile indicated in step 508 and the automobile shopping preference information from step 504 may relate to a variety of different aspects of automobiles, including price, features, location, and the like. For example, the computing device may, as part of determining the difference between the automobile purchased by the user and the automobile shopping preference information, determine that a feature indicated in the automobile shopping preference information is not available in the automobile purchased by the user. As another example, the computing device may, as part of determining the difference between the automobile purchased by the user and the automobile shopping preference information, determine that a price associated with the automobile purchased by the user is different from a range of prices indicated by the automobile shopping preference information.

The differences determined as step 509 might indicate significant detail about how users shop for vehicles and what they actually purchase. As a simple example, while some users might initially begin online shopping for fun sports cars and other exotic vehicles, most of those users might ultimately purchase reasonably responsible sedans and hatchbacks because of their lower price, reliability, or the like. As another example, while users might not necessarily search for vehicles with heated seats, they might ultimately purchase vehicles with heated seats when provided the opportunity. As yet another example, while a user might begin shopping for luxury sedans around fifty thousand dollars, they might be willing to purchase a luxury SUV for forty thousand dollars under certain circumstances. Such differences can imply significant amounts about a user's shopping habits and actual preferences which ultimately can be used to better train a machine learning model.

In step 510, the computing device may further train the trained machine learning model based on one or more differences between the purchased automobile indicated in step 508 and the automobile shopping preference information from step 504. For example, the computing device may further train the trained machine learning model by modifying, based on the difference between the automobile purchased by the user and the automobile shopping preference information, the one or more weights of the one or more nodes of the artificial neural network. In this way, the machine learning model may learn, over time, the realities of how users shop for vehicles and how they actually end up purchasing those vehicles. In turn, the trained machine learning model might provide better vehicle recommendations as part of step 506.

The overall process depicted in FIG. 5 effectively progressively trains the machine learning model. FIG. 5 effectively describes a process whereby, as the machine learning model outputs recommendations and monitors activity after those recommendations, it can learn a variety of things: whether users acted upon the recommendations (e.g., purchased a recommended vehicle), whether users purchased vehicles in accordance with their expressed auto shopping preferences, and the like. In turn, over time, the machine learning model can improve and provide better recommendations, which might increase the likelihood that users enjoy and act on those recommendations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device configured to progressively train an auto recommendation machine learning model based on differences between customer automobile searching preferences and actual automobile purchasing behavior, the computing device comprising:
one or more processors; and
memory storing instructions that, when executed by the one or more processors, cause the computing device to:
receive, from one or more search engines, search data indicating a history of auto shopping searches by one or more users;
generate training data comprising the search data and historical vehicle financing data;
generate a trained machine learning model by modifying, based on the training data, one or more weights of one or more nodes of an artificial neural network;
receive, from a user, automobile shopping preference information;
provide, as input to the trained machine learning model, the automobile shopping preference information;
receive, as output from the trained machine learning model, one or more recommended automobiles;
cause display, in a user interface, of the one or more recommended automobiles;
receive, after the display of the one or more recommended automobiles, an indication of an automobile purchased by the user;
determine a difference between the automobile purchased by the user and the automobile shopping preference information; and
further train the trained machine learning model by modifying, based on the difference between the automobile purchased by the user and the automobile shopping preference information, the one or more weights of the one or more nodes of the artificial neural network.

2. The computing device of claim 1, wherein the instructions, when executed by the one or more processors, cause the computing device to generate the training data by causing the computing device to:
determine a user associated with both:
a first search indicated by the history of auto shopping searches, and
a first auto loan indicated by the historical vehicle financing data; and
add, to the training data, an association between the first search and the first auto loan.

3. The computing device of claim 1, wherein the instructions, when executed by the one or more processors, cause the computing device to:
cause, based on the output from the trained machine learning model and in the user interface, output of a QR code that represents a Uniform Resource Locator (URL); and
provide, at a web page at the URL, the automobile shopping preference information.

4. The computing device of claim 1, wherein the instructions, when executed by the one or more processors, cause the computing device to determine the difference between the automobile purchased by the user and the automobile shopping preference information by causing the computing device to:
determine that a feature indicated in the automobile shopping preference information is not available in the automobile purchased by the user.

5. The computing device of claim 1, wherein the instructions, when executed by the one or more processors, cause the computing device to determine the difference between the automobile purchased by the user and the automobile shopping preference information by causing the computing device to:
determine that a price associated with the automobile purchased by the user is different from a range of prices indicated by the automobile shopping preference information.

6. The computing device of claim 1, wherein the instructions, when executed by the one or more processors, cause the computing device to cause display of the one or more recommended automobiles by causing the computing device to:
cause display of dealer information corresponding to each of the one or more recommended automobiles; and
transmit, to each dealer associated with the one or more recommended automobiles, an indication of the user.

7. The computing device of claim 1, wherein the instructions, when executed by the one or more processors, cause the computing device to receive the indication of the automobile purchased by the user by causing the computing device to:
access an e-mail account associated with the user;
process one or more e-mails of the e-mail account to identify an e-mail associated with an automobile purchase; and
determine, based on the e-mail associated with an automobile purchase, the indication of the automobile purchased by the user.

8. The computing device of claim 1, wherein the instructions, when executed by the one or more processors, cause the computing device to receive the indication of the automobile purchased by the user by causing the computing device to:
receive, via the user interface, user input comprising the indication of the automobile purchased by the user.

9. A method for progressively training an auto recommendation machine learning model based on differences between customer automobile searching preferences and actual automobile purchasing behavior, the method comprising:
receiving, from one or more search engines, search data indicating a history of auto shopping searches by one or more users;
generating training data comprising the search data and historical vehicle financing data;
generating a trained machine learning model by modifying, based on the training data, one or more weights of one or more nodes of an artificial neural network;
receiving, from a user, automobile shopping preference information;
providing, as input to the trained machine learning model, the automobile shopping preference information;
receiving, as output from the trained machine learning model, one or more recommended automobiles;
causing display, in a user interface, of the one or more recommended automobiles;
receiving, after the display of the one or more recommended automobiles, an indication of an automobile purchased by the user;
determining a difference between the automobile purchased by the user and the automobile shopping preference information by determining that a feature indicated in the automobile shopping preference information is not available in the automobile purchased by the user; and
further training the trained machine learning model by modifying, based on the difference between the automobile purchased by the user and the automobile shopping preference information, the one or more weights of the one or more nodes of the artificial neural network.

10. The method of claim 9, wherein generating the training data comprises:
determining a user associated with both:
a first search indicated by the history of auto shopping searches, and
a first auto loan indicated by the historical vehicle financing data; and
adding, to the training data, an association between the first search and the first auto loan.

11. The method of claim 9, further comprising:
causing, based on the output from the trained machine learning model and in the user interface, output of a QR code that represents a Uniform Resource Locator (URL); and
providing, at a web page at the URL, the automobile shopping preference information.

12. The method of claim 9, wherein determining the difference between the automobile purchased by the user and the automobile shopping preference information further comprises:
determining that a price associated with the automobile purchased by the user is different from a range of prices indicated by the automobile shopping preference information.

13. The method of claim 9, wherein causing display of the one or more recommended automobiles comprises:
causing display of dealer information corresponding to each of the one or more recommended automobiles; and
transmitting, to each dealer associated with the one or more recommended automobiles, an indication of the user.

14. The method of claim 9, wherein receiving the indication of the automobile purchased by the user comprises:
accessing an e-mail account associated with the user;
processing one or more e-mails of the e-mail account to identify an e-mail associated with an automobile purchase; and
determining, based on the e-mail associated with an automobile purchase, the indication of the automobile purchased by the user.

15. The method of claim 9, wherein receiving the indication of the automobile purchased by the user comprises:
receiving, via the user interface, user input comprising the indication of the automobile purchased by the user.

16. One or more non-transitory computer-readable media storing instructions that, when executed by a computing device configured to progressively train an auto recommendation machine learning model based on differences between customer automobile searching preferences and actual automobile purchasing behavior, cause the computing device to:
receive, from one or more search engines, search data indicating a history of auto shopping searches by one or more users;
generate training data comprising the search data and historical vehicle financing data;
generate a trained machine learning model by modifying, based on the training data, one or more weights of one or more nodes of an artificial neural network;
receive, from a user, automobile shopping preference information;
provide, as input to the trained machine learning model, the automobile shopping preference information;
receive, as output from the trained machine learning model, one or more recommended automobiles;
cause display, in a user interface, of the one or more recommended automobiles;
after the display of the one or more recommended automobiles:
access an e-mail account associated with the user;
process one or more e-mails of the e-mail account to identify an e-mail associated with an automobile purchase; and
determine, based on the e-mail associated with an automobile purchase, an indication of the automobile purchased by the user;
determine a difference between the automobile purchased by the user and the automobile shopping preference information; and
further train the trained machine learning model by modifying, based on the difference between the automobile purchased by the user and the automobile shopping preference information, the one or more weights of the one or more nodes of the artificial neural network.

17. The non-transitory computer-readable media of claim 16, wherein the instructions, when executed, cause the computing device to generate the training data by causing the computing device to:
determine a user associated with both:
a first search indicated by the history of auto shopping searches, and
a first auto loan indicated by the historical vehicle financing data; and
add, to the training data, an association between the first search and the first auto loan.

18. The non-transitory computer-readable media of claim 16, wherein the instructions, when executed, cause the computing device to:
cause, based on the output from the trained machine learning model and in the user interface, output of a QR code that represents a Uniform Resource Locator (URL); and
provide, at a web page at the URL, the automobile shopping preference information.

19. The non-transitory computer-readable media of claim 16, wherein the instructions, when executed, cause the computing device to determine the difference between the automobile purchased by the user and the automobile shopping preference information by causing the computing device to:
determine that a feature indicated in the automobile shopping preference information is not available in the automobile purchased by the user.

20. The non-transitory computer-readable media of claim 16, wherein the instructions, when executed, cause the computing device to determine the difference between the automobile purchased by the user and the automobile shopping preference information by causing the computing device to:
determine that a price associated with the automobile purchased by the user is different from a range of prices indicated by the automobile shopping preference information.
